(19) United States
(12) Patent Application Publication
(10) Pub. No.: US 2007/0223227 A1
(43) Pub. Date: Sep. 27, 2007

(54) Motor base with a lamp

(76) Inventor: Huang-Hsi Hsu, Taipei (TW)

Correspondence Address: BACON & THOMAS, PLLC, 625 SLATERS LANE, FOURTH FLOOR, ALEXANDRIA, VA, 22314, US

(21) Appl. No.: 11/387,788

(22) Filed: Mar. 24, 2006

(51) Int. Cl. F21V 21/26

(52) U.S. Cl. 362/269; 362/286; 362/386

(57) ABSTRACT

The present invention is about a motor base with a lamp including a base and a casing, wherein the base includes an axle hole on the base, a first connecting portion at the top of the base, and a first containing space therein, the first containing space contains a motor having an output axle; and the casing includes an opening and a second containing space therein, and the second containing space contains a lamp, and an end of the lamp is extended out of the opening, and the casing further includes a second connecting portion at the bottom of the casing, and the second connecting portion is movably coupled to the first connecting portion, such that the casing can be movably mounted onto the base, and the lamp can project onto an appropriate position.

### FIELD OF THE INVENTION

The present invention relates to a motor base with a lamp, and more particularly to a motor base including a base equipped a motor, and a casing with a lamp, which is movably disposed on the base for projecting onto an appropriate position.

### BACKGROUND OF THE INVENTION

As advanced life coming, people start to focus on stylish and tasty way on leisure activities, and thus barbeque activities for social function become very popular, but the barbeque stoves sold in the market still come with a simple design which is unfriendly or impractical. Obviously, excepting reasonable price, user-friendliness and utility become the key factors for consumers to choose barbeque stoves. In addition, the barbeque stove market is very competitive, manufacturers or designers in barbeque stove industry have to produce every barbeque stove with practical and user-friendly to grab the market sharing, and otherwise they will lose the market sharing.

Referring to FIG. 1 for the traditional rotisserie motor set, a rotisserie motor set 1 is installed at a side of a hollow stove 2, and the hollow stove 2 holds a space for containing any barbeque related objects such as jet-burner nozzles, nets, and coals, etc (not shown in the figure), and the rotisserie motor set 1 includes a hollow casing 10, and the hollow casing 10 contain a motor (not shown in the figure) therein, and includes an axle hole 100 disposed on a lateral thereof for inserting an end of a rod 3 precisely. If the motor drives the rod 3 to spin, then a piece of barbeque brochette (not shown in the figure) on the rod 3 will spin accordingly, so as to grill the food equally. Further, the power supply for the motor can be supplied by an external power supply (not shown in the figure) through an electric wire 102 on the hollow casing 10.

However, the foregoing rotisserie motor set still got some drawbacks in practice. If the barbeque is held in bright area, users can easily check the cooking level of food by eyes; however, if the barbeque is held in a dinner party with twilight, then users are unable to check the cooking level of food by eyes. Users usually slice a small piece from the barbeque food to check whether or not the food is cooked properly, and thus users may get ill by eating food with rare or medium. Thus, such design of rotisserie motor set 1 is not user-friendly and impractically and needs to be improved.

To solve the shortcomings of the prior art of rotisserie motor set when it is used in a dark area, related manufacturers develop a barbeque stove equipped with a lamp. In FIG. 1, a clamp 40, a pipe 41, and a lamp 42, wherein the clamp 40 clamps another side of a hollow stove 2, and an end of the pipe 41 is disposed on a surface of the clamp 40, and another end of the pipe 41 is coupled to the lamp 42, and the pipe 41 can be bent such that a light source emitted from the lamp 42 can be projected onto an appropriate position. If the barbeque is held in a dark area, the illumination of the lamp 42 can be used to check the cooking level of food.

However, such barbeque stove clamping with a lamp can project a light source for illuminations, yet it still has many shortcomings. Firstly, consumers have to purchase additional equipments, and thus incurring additional costs. Secondly, the rotisserie motor set 1 and the lamp 42 might require separate power cords, and thus users may be easily stumbled by these power cords near a hot hollow stove 2 to hurt users accidentally. Therefore, finding a way to design a user-friendly, functional, and convenient rotisserie motor set becomes an important subject for barbeque stove manufacturers and designers to solve.

### SUMMARY OF THE INVENTION

In view of the shortcomings of a prior art of the rotisserie motor set that makes the cooking level of food hard to check with twilight, or an extra lamp is needed, which incurs additional costs and causes an inconvenient use, the inventor of the present invention based on years of experience in the related field to conduct extensive researches and experiments, and finally invented a motor base with a lamp to provide a more functional and user-friendly barbeque stove.

Therefore, it is a primary objective of the present invention to provide a motor base with a lamp that comprises a base having a casing thereon, wherein the base includes an axle hole disposed on a lateral of the base, a first connecting portion disposed on a top surface of the base, and a first containing space defined therein, and the first containing space includes a motor having an output axle disposed at a position facing the axle hole for connecting a rod, such that the rod is driven by the motor and rotated with the output axle accordingly, and the casing includes an opening disposed on a lateral of the casing and a second containing space defined therein, and the second containing space contains a lamp, and an end of the lamp is extended out of the opening, and the casing further includes a second connecting portion disposed at a bottom surface of the casing, and the second connecting portion is movably coupled to the first connecting portion, such that the casing can be movably mounted onto the base, and a light source can be projected onto an appropriate position.

The above and other objects, features and advantages of the present invention will become apparent from the following detailed description taken with the accompanying drawings.

### BRIEF DESCRIPTION OF THE DRAWINGS

FIG. 1 is a schematic view of a rotary barbeque motor, a lamp, and a stove according to a prior art;

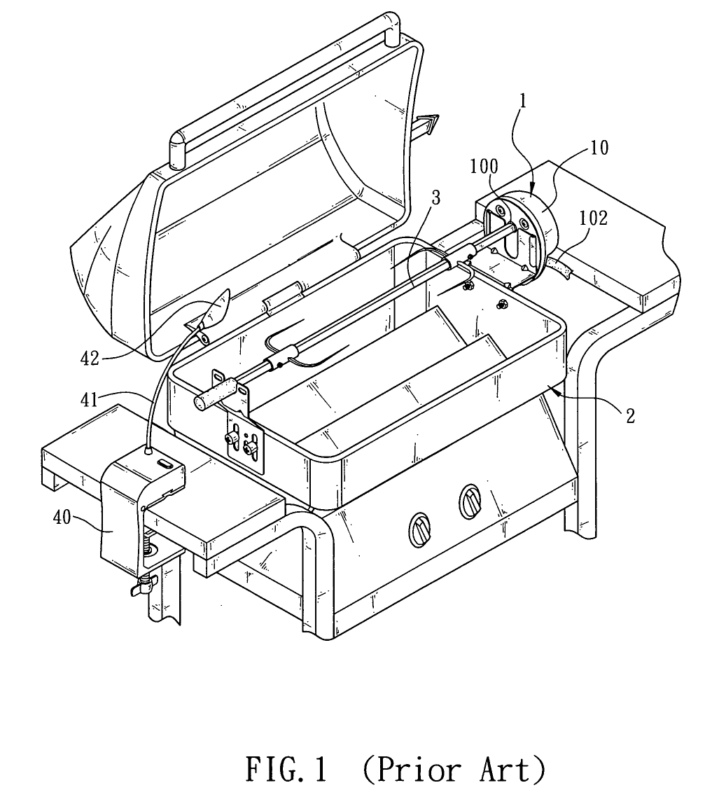

FIG. 2 is a perspective view of a motor base with a lamp of the invention;

FIG. 3 is a schematic view of disassembled parts of a motor base with a lamp of the invention;

FIG. 4 is a schematic view of a preferred embodiment of the invention;

FIG. 5 is a cross-sectional view of another preferred embodiment of the invention; and

FIG. 6 is a schematic view of disassembled parts of a chuck and an elastic element of the invention.

### DETAILED DESCRIPTION OF THE PREFERRED EMBODIMENTS

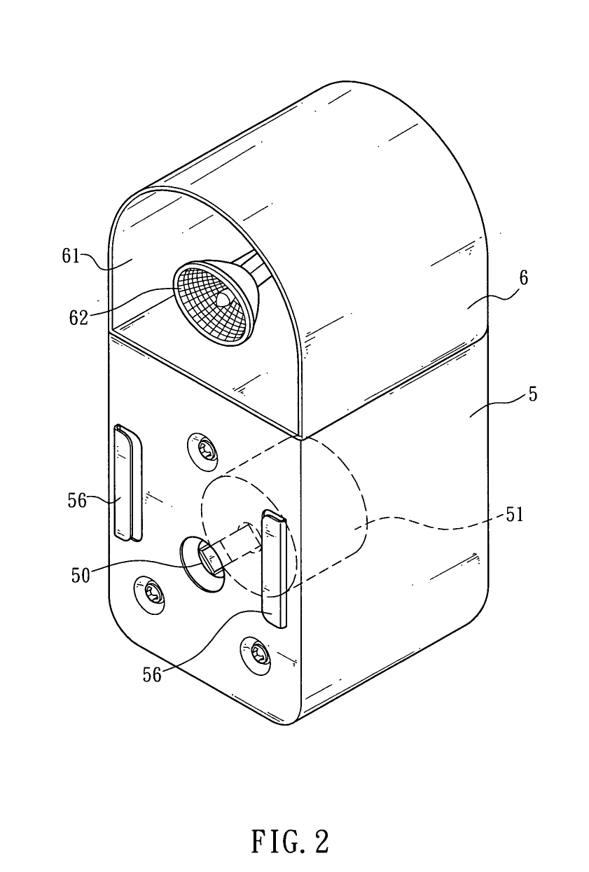

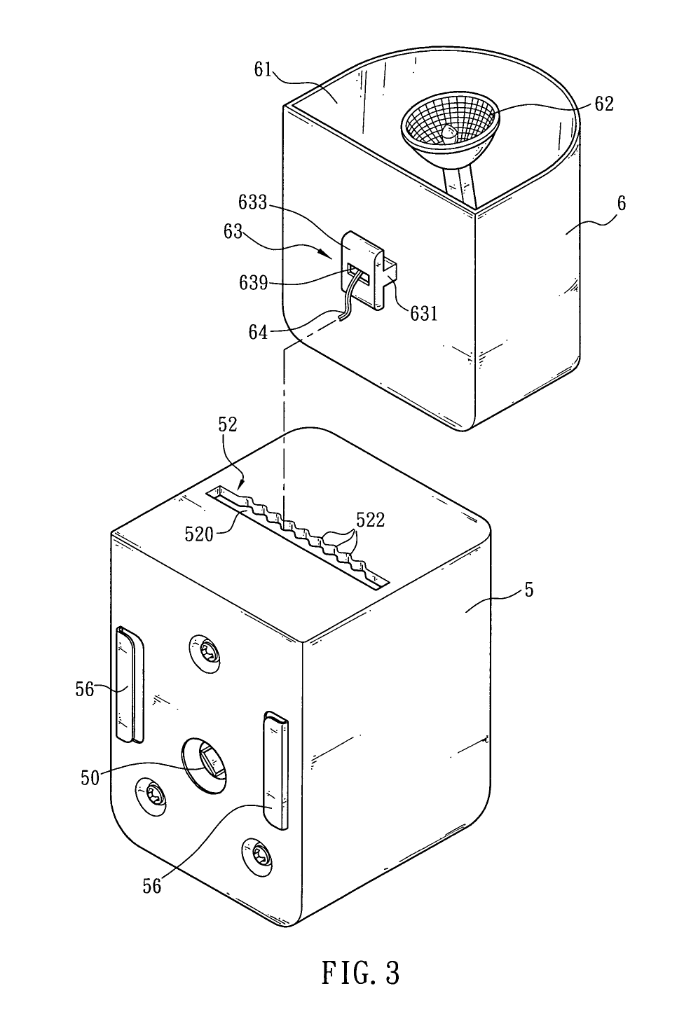

Referring to FIGS. 2 and 3, a motor base with a lamp in accordance with the present invention comprises a base 5 and a casing 6. The base 5 includes an axle hole 50 disposed at a lateral of the base 5 and a first connecting portion 52 at a top surface of the base 5, and the first connecting portion 52 is movably coupled to the casing 6, and the base 5 defines a first containing space therein, and the first containing space includes a motor 51, and the motor 51 has an output axle disposed at a position facing the axle hole 50, and the output axle is provided for connecting a rod, such that the rod can be driven by the motor 51 to rotate with the output axle. The casing 6 includes an opening 61 disposed at a lateral of the casing 6, and the casing 6 defines a second containing space therein, and the second containing space includes a lamp 62, and an end of the lamp 62 is extended out of the opening 61, and the casing 6 includes a second connecting portion 63 disposed at a bottom surface of the casing 6, and the second connecting portion 63 is movably coupled to the first connecting portion 52, such that the casing 6 can be movably mounted onto the base 5, and a light source produced by the lamp 62 can be projected onto an appropriate position by adjusting the position of the casing 6 on the base 5.

Referring to FIG. 3 for the preferred embodiment of the invention, the first connecting portion 52 includes a sliding track 520, and both ends of the sliding track 520 are proximate to both distal edges of the top surface of the base 5 respectively, and the second connecting portion 63 includes a chuck 631 and a latch member 633, and an end of the chuck 631 is disposed at the bottom surface of the casing 6 and capable of sliding between both ends of the sliding track 520, and the latch member 633 is disposed on another end of the chuck 631 and contained in the first containing space for preventing the casing 6 from falling off from the base 5. With this structure, the light source can be projected onto an appropriate position by adjusting the position of the casing 6 on the base 5.

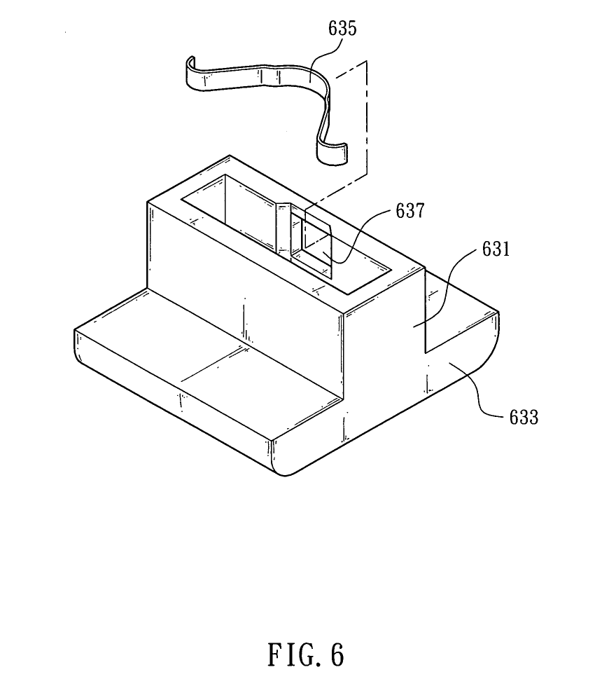

Referring to FIGS. 3 and 6 for the preferred embodiment of the invention, the first connecting portion 52 further includes a plurality of latch grooves 522 disposed continuously along a side of the sliding track 520, and the second connecting portion 63 further includes an elastic element 635, and both ends of the elastic element 635 are contained in the chuck 631, and a portion between both ends of the elastic element 635 is protruded from another opening 637 disposed on a side of the chuck 631 and facing the latch grooves 522 and precisely accommodated in one of the latch grooves 522. With the resilience of the elastic element 635 and the latch grooves 522 operating mutually, the casing 6 can be mounted stably onto the base 5 if no external pushing force is applied.

In the preferred embodiment as shown in FIG. 3, an end of a power cord 64 is connected to the lamp 62 in the casing 6, and another end of the power cord 64 is extended into the base 5 through a penetrating hole 639 of the chuck 631 and the sliding track 520.

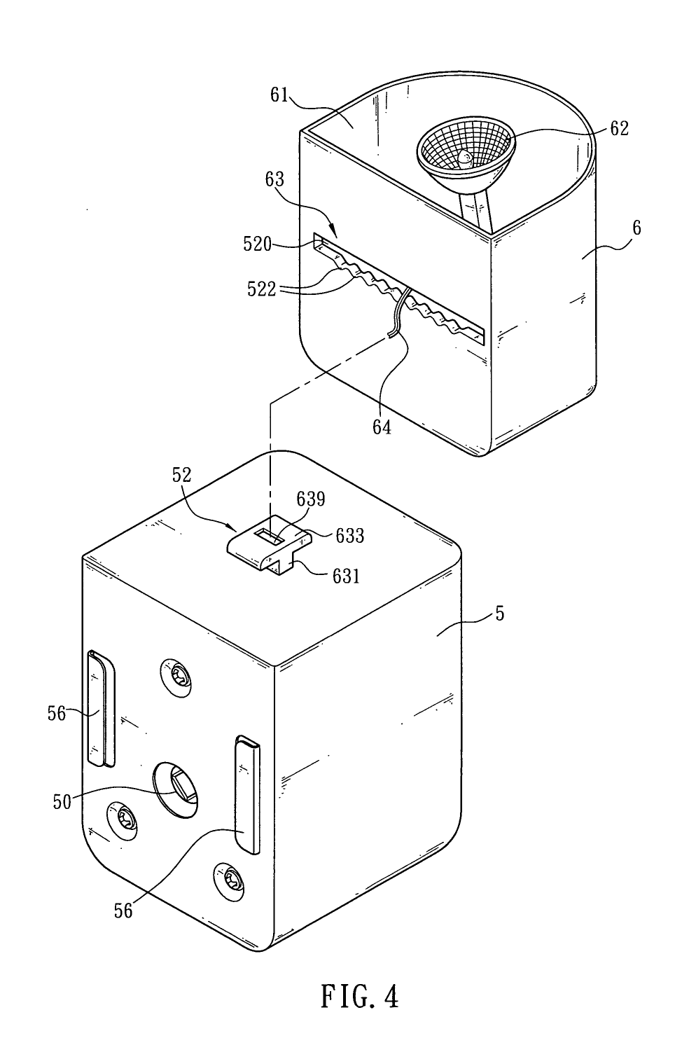

Referring to FIG. 4 for another preferred embodiment of the present invention, the first connecting portion 52 includes a chuck 631 and a latch member 633, and an end of the chuck 631 is disposed on the top surface of the base 5, and the latch member 633 is disposed on another end of the chuck 631, and the latch member 633 is contained in the second containing space for preventing the casing 6 from falling off from the base 5, and the second connecting portion 63 includes a sliding track 520, and both ends of the sliding track 520 are proximate to both distal edges of the bottom surface of the casing 6, and the sliding track 520 is provided for containing the chuck 631 and sliding the chuck 631 in the sliding track 520. With the foregoing structure, the light source can be projected onto an appropriate position by adjusting the position of the casing 6 on the base 5.

Referring to FIGS. 4 and 6 for the preferred embodiment, the second connecting portion 63 further includes a plurality of latch grooves 522 disposed continuously along a side of the sliding track 520, and the first connecting portion 52 further includes an elastic element 635, and both ends of the elastic element 635 are contained in the chuck 631, and a portion between both ends of the elastic element 635 is protruded out of another opening 637 disposed on a side of the chuck 631 and facing the latch grooves 522 and contained precisely in one of the latch grooves 522. With the resilience of the elastic element 635 and the latch grooves 522 operating mutually, the casing 6 can be mounted stably onto the base 5 if no external pushing force is applied.

In the preferred embodiment as shown in FIG. 4, an end of a power cord 64 is connected to the lamp 62 in the casing 6, and another end of the power cord 64 is extended into the base 5 through the sliding track 520 and a penetrating hole 639 of the chuck 631.

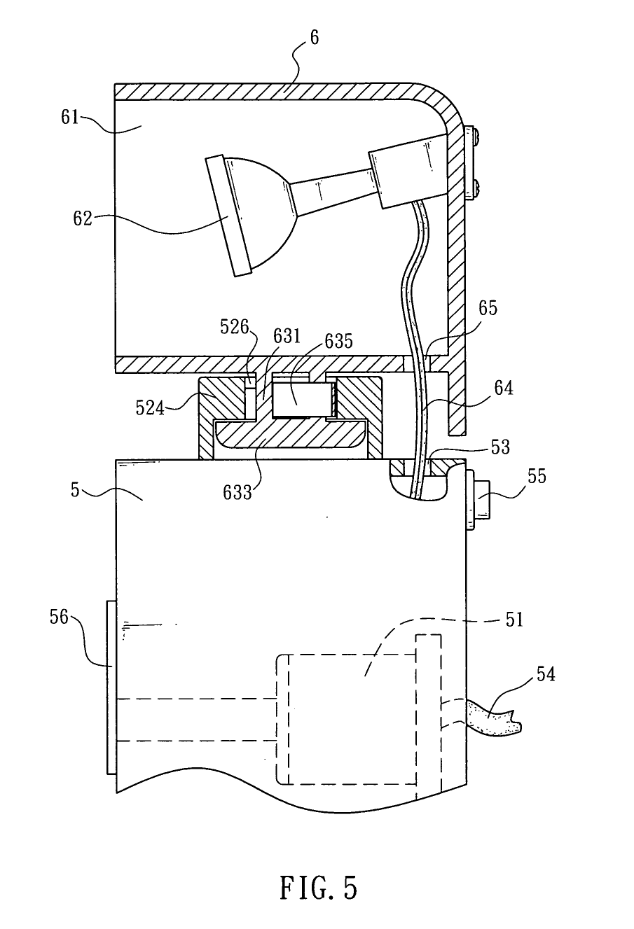

Referring to FIG. 5 for another preferred embodiment of the present invention, the first connecting portion 52 includes a cover 524, and both ends of the cover 524 are proximate to both distal edges of the top surface of the base 5 respectively, and the cover 524 includes a rectangular opening 526, and both ends of the rectangular opening 526 are extended proximate to both ends of the cover 524 respectively, and a third containing space is formed between the rectangular opening 526 and the base 5, and the second connecting portion 63 includes a chuck 631 and a latch member 633, wherein an end of the chuck 631 is disposed at the bottom surface of the casing 6, and the chuck 631 can slide in the rectangular opening 526, and the latch member 633 is disposed on another end of the chuck 631 and contained in the third containing space, so as to slide in the third containing space and prevent the casing 6 from falling off from the base 5. Therefore, the light source can be projected onto an appropriate position by adjusting the position of the casing 6 on the base 5.

Referring to FIGS. 5 and 6 for the preferred embodiment of the invention, the first connecting portion 52 further includes a plurality of latch grooves 522 disposed continuously along a side of the rectangular opening 526, and the second connecting portion 63 further includes an elastic element 635,and both ends of the elastic element 635 are contained in the chuck 631, and a portion between both ends of the elastic element 635 is protruded out of another opening 637 disposed on a side of the chuck 631 and facing the latch grooves 522 and accommodated precisely in one of the latch grooves 522. With the resilience of the elastic element 635 and the latch groove 522 operating mutually, the casing 6 can be mounted stably onto the base 5, if no external pushing force is applied.

In the preferred embodiment as shown in FIG. 5, an end of a power cord 64 is connected to the lamp 62 in the casing 6, and another end of the power cord 64 is extended into the base 5 through a first hole 65 at the bottom surface of the casing 6 and a second hole 53 at the top surface of the base 5.

In the foregoing embodiments as shown in FIG. 5, an end of an electric wire 54 is coupled separately to the motor 51 and another end of the power cord 64, and another end of the electric wire 54 is extended out of the base 5 for receiving an external power supply to supply electric power to the motor 51 and the lamp 62.

In the mentioned embodiments as shown in FIG. 5, the base 5 includes at least one switch 55 for controlling the motor 51 and the lamp 62, and the base 5 includes at least one embedding element 56 disposed on a lateral proximate to the axle hole 50, and the embedding elements 56 is provided for embedding the base 5 onto a stove.

While the invention herein disclosed has been described by means of specific embodiments, numerous modifications and variations could be made thereto by those skilled in the art without departing from the scope and spirit of the invention set forth in the claims.

What is claimed is:

1. A motor base with a lamp, comprising:
a base, having an axle hole disposed at a lateral of said base, and a first connecting portion disposed at a top surface of said base, and defining a first containing space, and said first containing space containing a motor, and said motor including an output axle disposed at a position facing said axle hole; and
a casing, having an opening disposed on a lateral of said casing, and said opening defining a second containing space, and said second containing space including a lamp therein, and an end of said lamp being extended out of said opening for projecting a light source, and said casing having a second connecting portion disposed at a bottom surface of said casing and movably coupled to said first connecting portion, and said casing being movably mounted onto said base.

2. The motor base of claim 1, wherein said first connecting portion includes a sliding track, and both ends of said sliding track are proximate to both distal edges of a top surface of said base respectively.

3. The motor base of claim 2, wherein said second connecting portion comprises:
a chuck, with an end disposed on a bottom surface of said casing and movably accommodated into both ends of said sliding track; and
a latch member, disposed on another end of said chuck and movably contained in said first containing space.

4. The motor base of claim 3, wherein said first connecting portion further includes a plurality of latch grooves disposed continuously along a side of said sliding track.

5. The motor base of claim 4, wherein said second connecting portion further includes an elastic element, and both ends of said elastic element are contained in said chuck, and a portion between both ends of said elastic element is protruded out of another opening disposed on a side of said chuck and facing said latch grooves and contained in one of said latch grooves.

6. The motor base of claim 5, wherein said lamp in said casing is connected with an end of a power cord, and another end of said power cord is extended into said base through a penetrating hole of said chuck and said sliding track.

7. The motor base of claim 6, wherein said base further includes an electric wire, and an end of said electric wire is coupled separately to said motor and said power cord, and another end of said electric wire is extended out of said base, and said electric wire is provided for receiving an external power supply for supplying electric power to said motor and said lamp.

8. The motor base of claim 7, wherein said base includes at least one embedding element disposed on a lateral of said base and proximate to said axle hole for embedding said base onto a stove.

9. The motor base of claim 1, wherein said first connecting portion comprises:
a chuck, with an end disposed on a top surface of said base; and
a latch member, disposed on another end of said chuck and contained in said second containing space.

10. The motor base of claim 9, wherein said second connecting portion includes a sliding track having both ends proximate to both distal edges at a bottom surface of said casing and provided for said chuck to be movably contained in said sliding track.

11. The motor base of claim 10, wherein said second connecting portion further comprises a plurality of latch grooves disposed continuously along a side of said sliding track.

12. The motor base of claim 11, wherein said first connecting portion further comprises an elastic element, and both ends of said elastic element are contained in said chuck, and a portion between both ends of said elastic element is protruded out of another opening disposed on a side of said chuck and facing said latch grooves and accommodated in one of said latch grooves.

13. The motor base of claim 12, wherein said lamp in said casing is coupled with an end of said power cord, and another end of said power cord is extended into said base through said sliding track and a penetrating hole in said chuck.

14. The motor base of claim 13, wherein said base further includes an electric wire, and an end of said electric wire is coupled separately to said motor and another end of said power cord, and another end of said electric wire is extended out from said base for receiving an external power supply to supply electric power to said motor and said lamp.

15. The motor base of claim 14, wherein said base includes at least one embedding element disposed on a lateral of said base and proximate to said axle hole for embedding said base on a stove.

16. The motor base of claim 1, wherein said first connecting portion includes a cover, and both ends of said cover are proximate to both distal edges of a top surface of said base, and a rectangular opening is disposed thereon, and both ends of said rectangular opening are extended proximate to both ends of said cover, and a third containing space is formed between said rectangular opening and said base.

17. The motor base of claim 16, wherein said second connecting portion comprises:
a chuck, with an end disposed at the bottom surface of said casing, and said chuck being movably contained in said rectangular opening; and
a latch member, disposed on another end of said chuck and movably contained in said third containing space.

18. The motor base of claim 17, wherein said first connecting portion further includes a plurality of latch grooves disposed continuously along a side of said rectangular opening.

19. The motor base of claim 18, wherein said second connecting portion further includes an elastic element and both ends of said elastic element are contained in said chuck, and a portion between both ends of said elastic element is protruded out of another opening disposed at a side of said chuck and facing said latch grooves and contained in one of said latch grooves.

20. The motor base of claim 19, wherein said lamp in said casing is coupled with an end of said power cord, and another end of said power cord is extended into said base through a first hole disposed at a bottom surface of said casing and a second hole disposed at a top surface of said base.

21. The motor base of claim 20, wherein said base further includes an electric wire, and an end of said electric wire is coupled separately to said motor and another end of said power cord, and another end of said electric wire is extended out of said base to receive an external power supply for supplying electric power to said motor and said lamp.

22. The motor base of claim 21, wherein said base includes at least one embedding element disposed on a lateral proximate to said axle hole for embedding said base onto a stove.
